(19) United States
(12) Patent Application Publication
(10) Pub. No.: US 2002/0191031 A1
(43) Pub. Date: Dec. 19, 2002

(54) Image navigating browser for large image and small window size applications

(75) Inventor: Gary Ross Ricard, Chatfield, MN (US)

Correspondence Address: Steven W. Roth, IBM Corporation, Dept. 917, 3605 Highway 52 North, Rochester, MN, 55901-7829, US

(73) Assignee: INTERNATIONAL BUSINESS MACHINES CORPORATION, ARMONK, NY

(21) Appl. No.: 09/843,566

(22) Filed: Apr. 26, 2001

(51) Int. Cl. G06F 3/14

(52) U.S. Cl. 345/838

(57) ABSTRACT

The browser of the present invention presents the user with a small window, called a thumbnail, in addition to the user's normal window, or in the case of a small screen device, as a small window on the user's screen. A retrieved page image presented by the browser is logically divided into segments through use of the thumbnail. The size of each segment is based upon the size of the user's window or screen and upon the size of the page image. The thumbnail window contains a scaled-down version of the page image. The thumbnail image is divided into cells, one cell for each page image segment. When taken together, the cells form an image grid. Each cell is encoded with hotspot information to form a mapping between it and the associated page image segment. When the user selects a cell on the thumbnail, the browser of the present invention presents the associated segment of the page image to the user via the user's window or screen. As a further feature, the page image used can be adjusted in size to be larger than the original retrieved page image (e.g., web page image) as an aid to sight-impaired individuals.

### FIELD OF THE INVENTION

The present invention relates to data processing systems. More particularly, the present invention relates to the use of browser for large image and/or small window size applications.

### BACKGROUND OF THE INVENTION

In years past, computer system technology was used primarily by engineers, scientists, or computer-oriented individuals who supported large businesses. With the proliferation of personal computers in the 1980s and 1990s and the more recent acceptance of the internet, many different types of computer systems are now used by a wide variety of individuals.

In today's computer system world, a specific type of computer program, called a browser, is arguably the most widely used computer system tool. This wide acceptance is largely attributable to the standardized protocol and file format used on the internet. Computer system users are able to access and view a significant amount of information. As is commonly understood, this information comes to the user in the form of pages (called web pages in the internet context). Each page includes information elements that come in a variety of forms, including textual information (i.e., text) and images.

When the browser retrieves a page for the user, the browser considers the window size, formats the page's information elements in a particular way, and presents the page to the user as one large image (called a page image). If the user adjusts the size of his or her window, the browser considers the new window size, formats the information elements anew, and again presents the page to the user. The user can then point to and select different locations on the page to cause the browser to retrieve another page. Of course, this process can continue for as long as the user chooses.

Existing browsers are designed to operate using a fairly large display screen (i.e., a computer monitor), such as those commonly used with personal computers. For this reason, the information elements that make up a page (e.g., text and image information) are specified as being a particular size. Text, for example, is specified to be a specific font size and images are provided having a specific height and width. The chosen size of these information elements is established ahead of time for each page, which generally works well on display screens that are more or less standard in size.

While browser technology is not new, and in fact predates the internet's popularity, the internet has driven the wide spread use of browser technology on different devices. Herein lies two problems. First, standard size information elements are too big to work well with small display screen devices. The ever-popular cell phones, personal digital assistants (PDAs), and pocket personal computers are but a few examples. Second, standard size information elements are too small for sight-impaired users who want to make the information elements bigger, but can't.

While existing browser technology does not include a comprehensive solution to these problems, existing browsers do provide certain user adjustments represent partial solutions. As mentioned, browser users can adjust the window size of their browser. However, this only affects the size of the page background and possibly how the information elements are organized on the page, but does not affect the size of the information elements themselves. Some browsers similarly allow the user to manually adjust the font size of text information elements, but not image information elements. While this manual adjustment can help sight-impaired users read text, it does not help sight-impaired users view images. Moreover, the ability to reduce font size does not solve the small window/screen problem because reducing font size to the point where it can fit into a small window or screen often makes the text too small to read.

The overall usefulness of small display screen devices will continue to be impaired without a comprehensive solution to the problems identified above.

### SUMMARY OF THE INVENTION

An enhanced browser is disclosed. The browser essentially operates in two different modes. These modes are referred to as “thumbnail mode” and “non-thumbnail mode.” In thumbnail mode, the browser of the present invention presents the user with a small window, called a thumbnail. The thumbnail is presented in addition to the user's normal window or as a small window on the user's screen in the case of a small screen device. The page image presented by the browser is logically divided into segments through use of the thumbnail. The size of each segment is based upon the size of the user's window or screen and the size of the page image. The thumbnail window contains a scaled-down version of the page image. The thumbnail image is divided into cells, one cell for each page image segment. When taken together the cells form a grid. Each cell is encoded with hotspot information to form a mapping between it and the associated page image segment. When the user selects a cell on the thumbnail, the browser of the present invention presents the associated segment of the page image to the user via the user's window or screen. As a further feature, the page image used can be adjusted in size to be larger than the original retrieved page image (e.g., web page image) as an aid to sight-impaired individuals.

In non-thumbnail mode, the browser of the present invention automatically scales the original page image to fit into the user's display window or screen. This scaling is performed on all of the information elements within the original page image, making for a uniform presentation of the page to the user.

### BRIEF DESCRIPTION OF THE DRAWINGS

FIG. 1 is a block diagram of the computer system used in the preferred embodiment of the present invention.

FIGS. 2A through 2C are mock-up screen shots showing the thumbnail window and display window used in the preferred embodiment.

FIGS. 3A through 3C are flow diagrams depicting the steps used to carryout the HTTP Browser of the preferred embodiment.

FIG. 4 is a block diagram showing the image record used in the preferred embodiment.

### DESCRIPTION OF THE PREFERRED EMBODIMENT

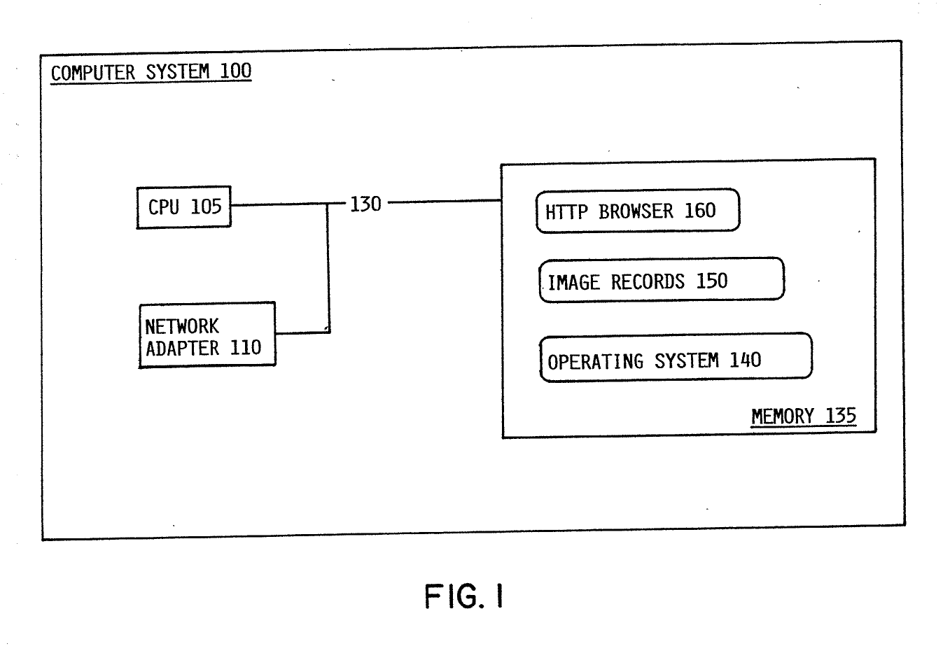

Turning now to the drawings, FIG. 1 shows a block diagram of the computer system of the preferred embodiment. The computer system of the preferred embodiment is an enhanced IBM Personal Computer 300PL. While computer system 100 of the preferred embodiment is a particular type of computer system, those skilled in the art appreciate that the benefits and advantages of the present invention apply equally to any computer system, regardless of whether the computer system is a complicated multi-user computing apparatus, a single user workstation, or a handheld device. In addition, the benefits and advantages are similarly applicable regardless of whether the computer system stands alone or participates in a computer system network. As shown in the exploded view of FIG. 1, computer system 100 comprises main or central processing unit (CPU) 105 connected to memory 135 and network adapter 110. These system components are interconnected through the use of system bus 130.

Computer system 100 of the preferred embodiment utilizes well-known virtual addressing mechanisms, allowing its programs to work against a large virtual storage aggregate instead of against multiple, smaller storage entities. Memory 135 is, however, shown on FIG. 1 as a monolithic entity because the programs of the preferred embodiment are not dependent upon any one type of memory management arrangement.

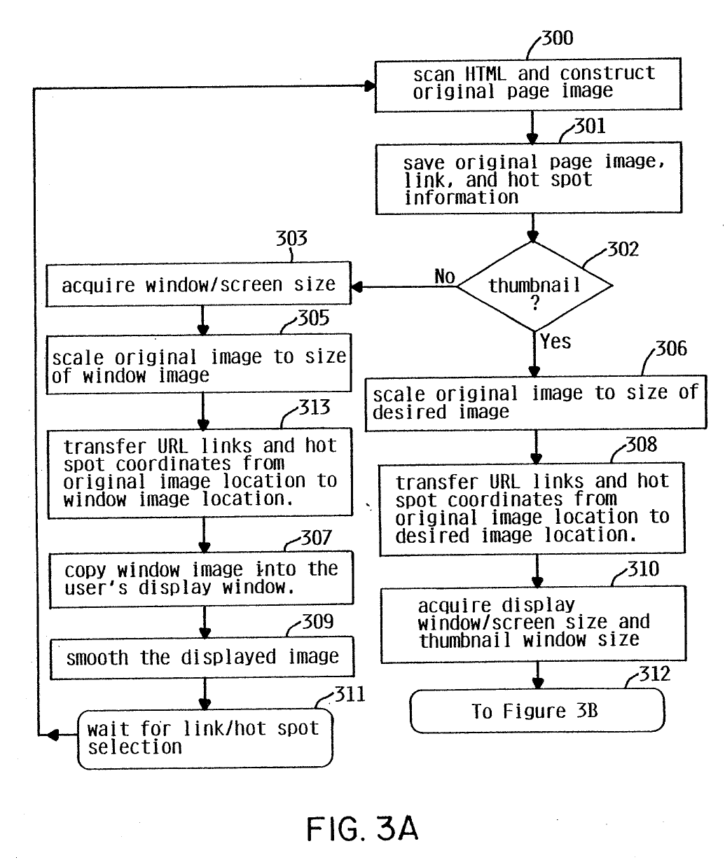

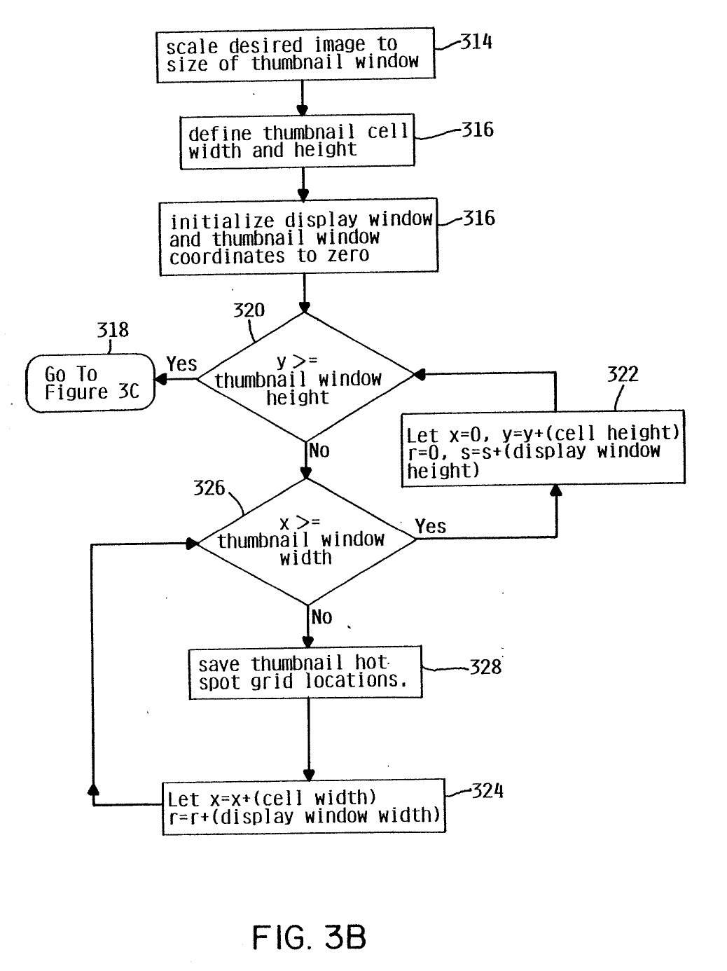

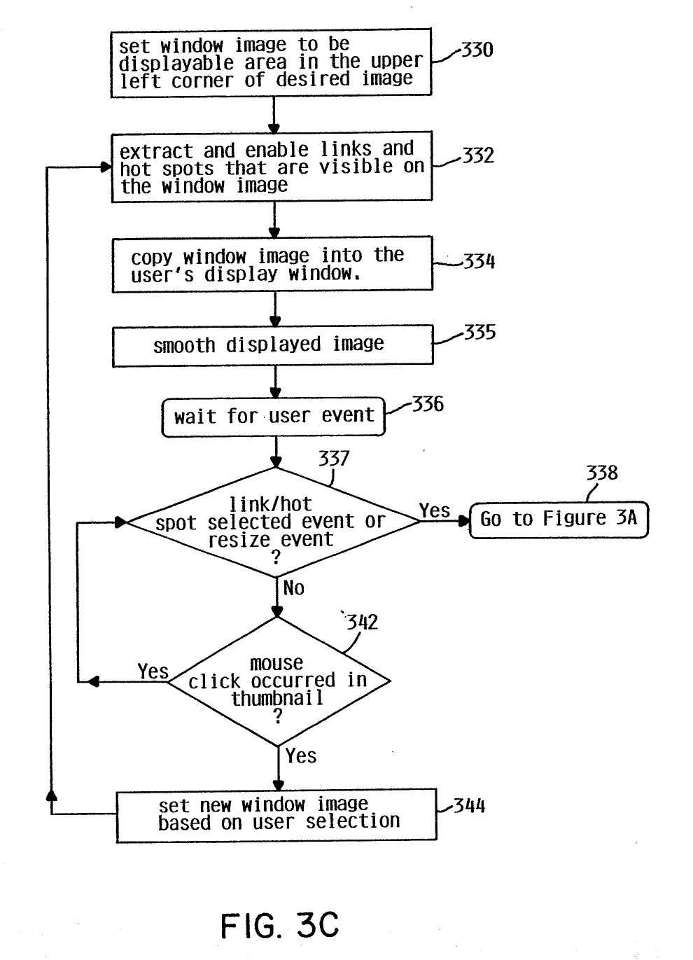

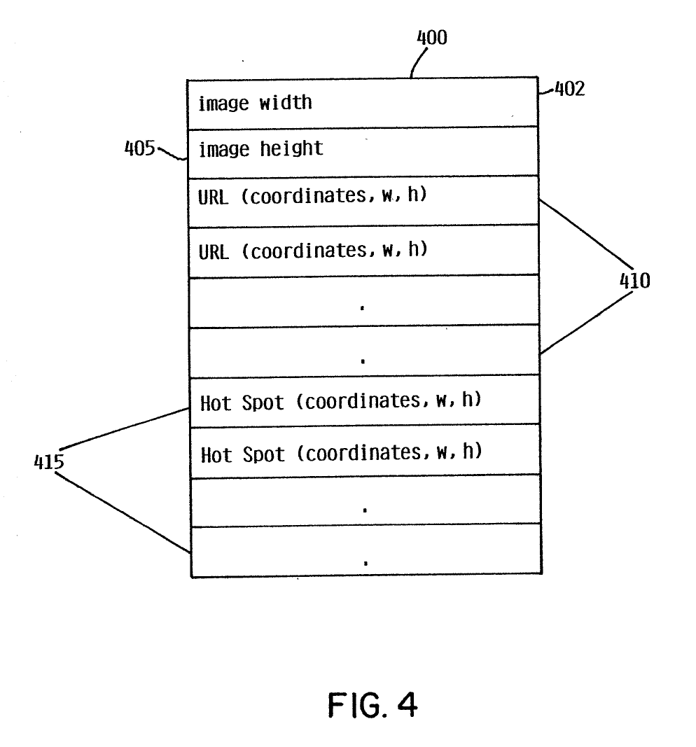

There are two programs shown to reside in memory 135. Operating system 140 of the preferred embodiment is the multitasking operating system known in the industry as Windows 2000®, which is licensed by Microsoft Corporation. However, those skilled in the art will appreciate that the spirit and scope of the present invention is not limited to any one operating system. The browser of the preferred embodiment, shown in memory 135 as HTTP Browser 160, operates using the HTTP protocol. As such, HTTP Browser 160 operates within internet and/or intranet networks. However, those skilled in the art will appreciate that the present invention is not limited to any particular protocol or to any particular network type. Also shown are image records 150, which are used in the preferred embodiment to store information about page images received by HTTP Browser 160. HTTP Browser 160 and image records 150 are described in more detail in the text accompanying FIGS. 3A through 4.

Also shown within computer system 100 is network adapter 110. Network adapter 110 is used to allow computer system 100 to be part of different networks (e.g., internet/intranet networks).

It is important to note that while the present invention has been (and will continue to be) described in the context of a fully functional computer system, the mechanisms of the preferred embodiment are capable of being distributed as a program product in a variety of forms, and there is no limitation as to the particular type of signal bearing media used to actually carry out such distribution. Examples of signal bearing media include: recordable type media such as floppy disks and CD ROMs and transmission type media such as digital and analog communications links.

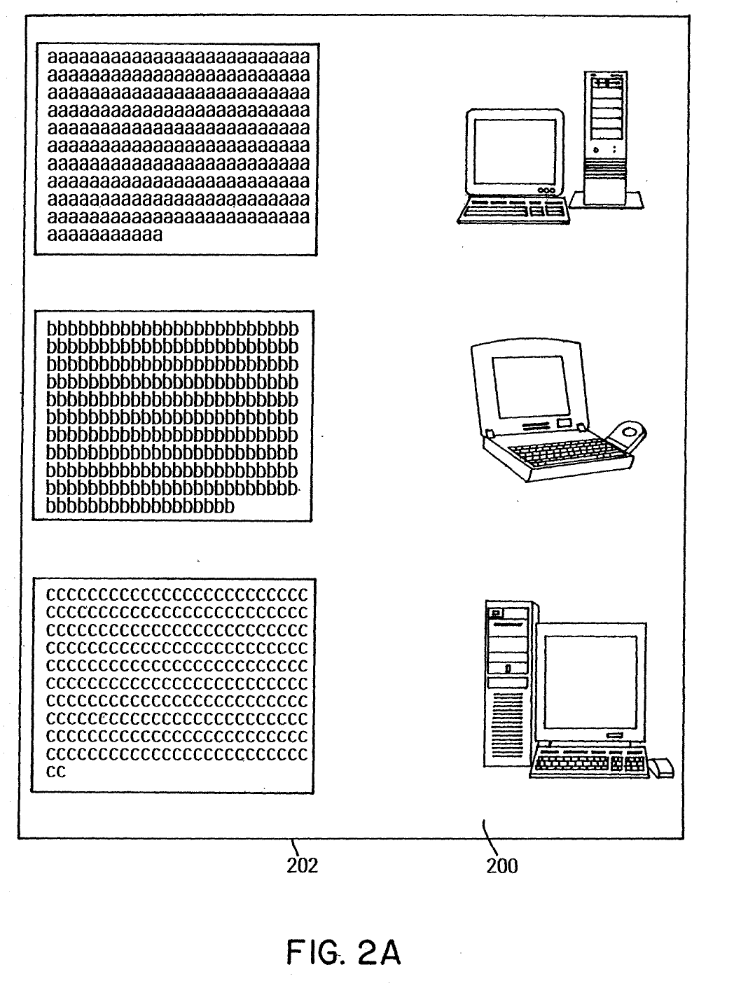

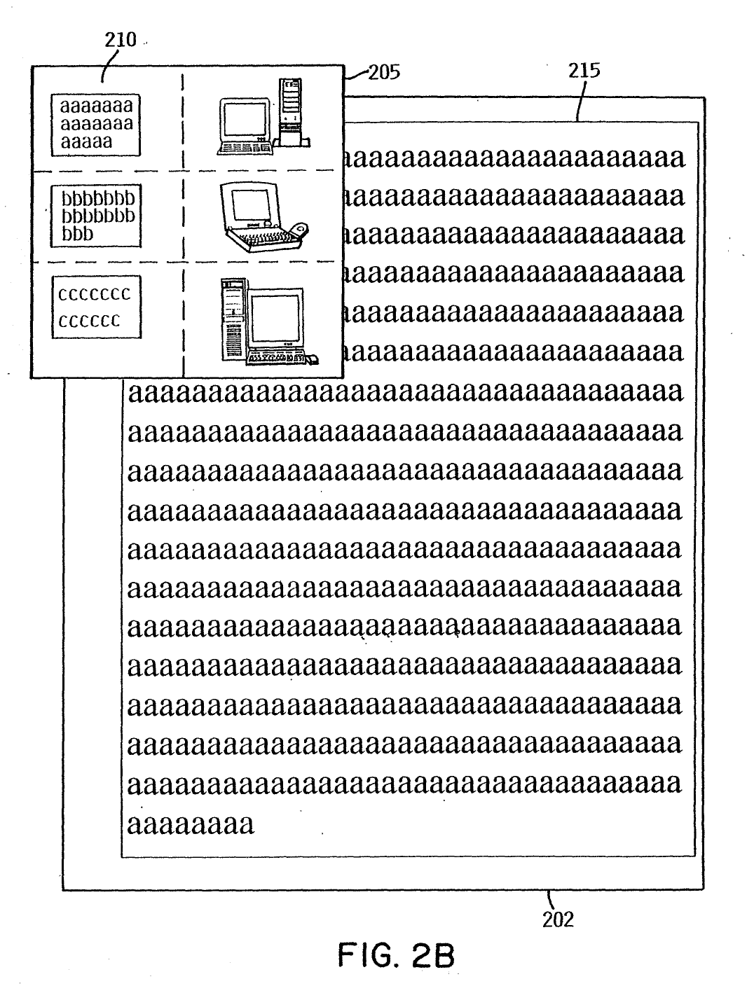

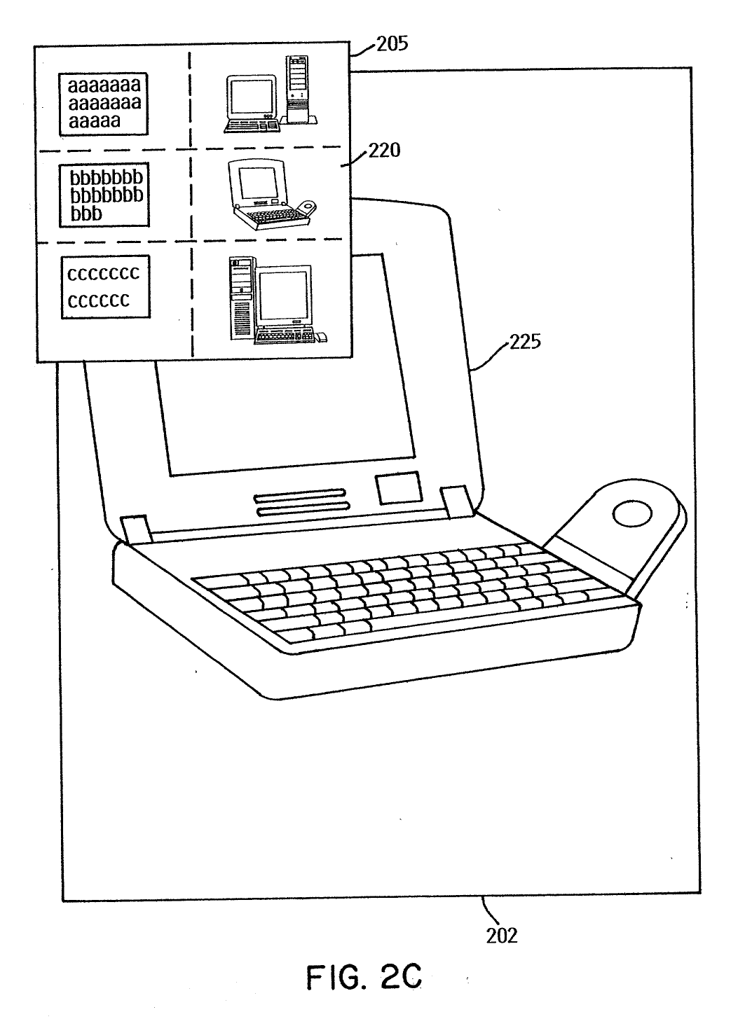

FIGS. 2A through 2C are mock-up screen shots showing the thumbnail window and display window used in the preferred embodiment. FIG. 2A shows a display window 202 as it would appear without use of the mechanisms of the preferred embodiment. Using the terminology of the preferred embodiment, this figure shows original page image 200 as it would be portrayed to the user via display window 202. FIG. 2B shows thumbnail 205 and display window 202. As shown, thumbnail 205 is an image grid that is made up of six cells. While dashed grid lines are used in the preferred embodiment, options include other types of visual separators or no separators at all. The user has selected cell 210 and therefore is presented with associated segment 215 in display window 202. FIG. 2C again shows thumbnail 205 and display window 202. In this case, the user has selected cell 220 and therefore is presented with associated segment 225 in display window 202.

FIGS. 3A through 3C are flow diagrams depicting the steps used to carryout the HTTP Browser of the preferred embodiment. Turning first to FIG. 3A, HTTP Browser 160 begins processing in block 300 where it retrieves an HTML page, scans the page, and constructs what is referred to herein as the original page image or “original image” for short.” This original image is that which would at this point be presented to the user. It is also important here to note that the source of the HTML page is not important vis-à-vis the logic of HTTP Browser 160. The page may be loaded via the internet or an intranet or be loaded directly from memory 135.

In processing block 301, HTTP Browser 160 saves the original page image and link and hot spot information into one of image records 150. Within the nomenclature of the preferred embodiment, the term “link” refers to hypertext links, which are well understood in the art. The term “hot spot” refers to a section or area of an image that is given navigation capabilities to allow the user to move to a different location (e.g., to another page or to another location within the current page). Turning now to FIG. 4, shown is image record 400. In the preferred embodiment, image record 400 is a separate storage record that is used by HTTP Browser 160; however, it should be understood that the information stored within image record 400 could be stored in some other browser-accessible data structure. Image field 401 is used to store the original page image itself while image width and height fields (402 and 405 respectively) are used to store the width and height of the original page image once it has been created from the received HTML by HTTP Browser 160. Universal Resource Locator (URL) fields 410 are used to store the URL locations in x, y coordinate form and to store the width and height of URLs found on the original page image. Similarly, hot spot fields 415 are used to store the hot spot locations in x, y coordinate form and to store the width and height of the hot spots found on the original page image.

Decision block 302 represents the option of having or not having a thumbnail as part of the presentation to the user. In the preferred embodiment, a thumbnail is used as a map to provide context and navigation in the case where that which is to be displayed to the user is larger than the user's screen or window size. When applicable, the user has the option of using a thumbnail window in addition to his or her normal window or screen. (The exact way in which this selection is accomplished by the user and made available to HTTP Browser 160 is not important and is, therefore, not addressed here.) Assuming first that a thumbnail window is not an option because that which is to be displayed is not larger than the user's screen or window size or because the thumbnail option is not selected by the user, HTTP Browser 160 proceeds to block 303 where the window size or screen size is acquired. The window size is acquired in the case where the preferred embodiment is being practiced in a window-oriented environment. That is, where different programs render information to the user via different windows. The screen size is acquired in an environment where the small size of the screen typically dictates that the entire screen is needed to adequately render the information (e.g., a PDA, cell phone, or other handheld device).

After the applicable size has been determined (i.e., window or screen), HTTP Browser 160 proceeds to scale the original page image such that it fits into the window or screen [processing block 305]. It is important to note that the original image may be scaled down to fully fit into a smaller window or screen or scaled up to fully fit into a larger window or screen. This image is referred to herein as the “window image” because it is equal in size to the user's window or screen. In the preferred embodiment, scaling is accomplished using well-known pixel expansion and compression techniques. After the image has been scaled, the URL link and hot spot locations are transferred from the original image location to the corresponding window image location [processing block 313]. The links and hotspots are similarly scaled to a size appropriate for given window or screen size. Table 1 below shows the calculations used in the preferred embodiment to accomplish this transfer.

TABLE 1

| New Location/Dimension | Calculation |
|---|---|
| URL or hot spot x coordinate | (original x)*(new image width)/(original |
| | page image width) |
| URL or hot spot y coordinate | (original y)*(new image height)/(original |
| | page image height) |
| URL or hot spot width | (original width)*(new image width)/ |
| | (original image width) |
| URL or hot spot height | (original height)*(new image height)/ |
| | (original page image height) |

After the URLs and hot spots have been transferred onto the window image, the window image is copied into the user's display window or screen [processing block 307] and smoothed [processing block 309]. Standard smoothing techniques are used in the preferred embodiment to enhance the presentation of the image to the user. Other techniques such as edge detection/enhancement and anti-aliasing can also be used. HTTP Browser 160 then waits for a user event in processing block 311. The user may choose to terminate execution of HTTP Browser 160, in which case processing simply ends (not shown), or the user may choose to navigate elsewhere by selecting a URL or a hot spot, in which case HTTP Browser 160 proceeds to processing block 300 to begin the process anew.

Assuming now that a thumbnail window is an option and is selected by the user, HTTP Browser 160 proceeds to block 306 instead of block 303 and constructs what is termed herein as the “desired page image” or “desired image” for short. As used herein, the desired page image can be larger or smaller than the original page image, but must be larger than the ultimate window image. This restriction is not a technical one but instead stems from the observation that there is no real benefit associated with a desired page image that was smaller than the window image. Thus, a user may decide that he or she would like the desired image page to be smaller than the original page image, but larger than the window image, or the user (particularly a sight-impaired user) may decide that the desired image size should be larger than the original image size. Moreover, the user may decide that the desired image should be the same size as the original image, which is the default selection used in the preferred embodiment. (The exact way in which the user specifies the desired image size is not important, and accordingly, not discussed here.) In any case, the desired page image is constructed (i.e., scaled) using the techniques described above.

The URL and hot spot locations are scaled and transferred as described in Table 1 [processing block 308] and the window/screen size is acquired [processing block 310].

Turning now to FIG. 3B, the thumbnail image is created by scaling the desired image to the size of the thumbnail window [processing block 314]. The width and height for thumbnail cells are then calculated in block 316. As discussed above, the thumbnail of the preferred embodiment is an image grid that is split up into two or more cells. These cells act as navigation aids for the user. The number of cells depends on the degree to which the desired image size is larger than the window image size. For example, if the desired image is four times larger than the window image, the thumbnail image will be split into four cells. Thus, each cell in the thumbnail grid corresponds to a segment of the desired image. This correspondence creates a logical mapping between the thumbnail grid and the desired image grid. Generally speaking, each segment is the same size as the display window or screen. However, it should be noted that the desired image size may not be evenly divisible by the window or screen size, meaning that cells and segments which terminate rows and/or columns may be narrower or shorter respectively than other cells and segments. The following calculations are used in the preferred embodiment to arrive at the cell width and height.

TABLE 2

| Cell Dimension | Calculation |
|---|---|
| Cell Width | (display window width)*(thumbnail window width)/ |
| | (desired image width) |
| Cell Height | (display window height)*(thumbnail window height)/ |
| | (desired image height) |

The display window and thumbnail window coordinates are then initialized to zero in processing block 316. These coordinates are represented on FIG. 3B by the variables x and y for the thumbnail window and by the variables r and s for the display window.

Processing blocks 320 through 328 represent the logic used in the preferred embodiment to define the thumbnail grid and thereby logically segment the desired image into a grid of segments. In decision block 320, HTTP Browser 160 determines whether the y coordinate is greater than the thumbnail window height. On this first pass though the logic, the y coordinate will still be zero. Thus, HTTP Browser 160 proceeds to block 326 where it determines whether the x coordinate of the thumbnail window is greater than the thumbnail window width. The x coordinate will similarly be zero, meaning that HTTP Browser 160 proceeds to block 328 where a hot spot in the thumbnail image for the first cell is created. The hot spot area for the cell is defined by its lower left corner (x,y) and its upper right corner (x+(cell width)−1, y+(cell height)−1). The hot spot on the thumbnail image corresponds to a particular segment of the desired image, which is defined by its lower left corner (r,s) and its upper right corner (r+(display window width)−1, s+(display window height)−1).

After the first cell has been created, HTTP Browser 160 proceeds to the next cell in the row by incrementing the x coordinate by the cell width and by incrementing the r coordinate by the width of the display window [processing block 324]. HTTP Browser 160 then checks to see whether it has past the last cell in the row. If not, blocks 328 and 324 are repeated. If HTTP Browser 160 has reached the last cell in the row, it proceeds to the next row in the thumbnail grid by incrementing the y and s coordinates [processing block 322]. When all the cells in all the rows have been created, decision block 320 evaluates to TRUE, which causes HTTP Browser 160 to move on to the logic set forth on FIG. 3C.

Turning now to FIG. 3C, HTTP Browser 160 sets the window image to be the segment of the desired image which corresponds to the upper left most cell of the thumbnail grid [processing block 330]. HTTP Browser 160 then determines which links and or hot spots should be made visible in the window image, and proceeds to extract and then enable those links and hot spots through reference to image record 400. Once the links and hot spots have been processed, the window image is copied into the user's display window [block 334] and smoothed [block 335]. HTTP Browser 160 then waits for a user event in block 336. If the user selects a link or a hot spot or resizes the display or the thumbnail windows, HTTP Browser 160 will repeat the above-described processing beginning with processing block 300 of FIG. 3A. If the user selects one of the hot spot areas within the thumbnail grid, HTTP Browser 160 sets the new window image based on the coordinates of the user's selection within the thumbnail (i.e., the selected cell in the grid) [processing block 344] and proceeds to block 332 to display the image as has been described above.

The embodiments and examples set forth herein were presented in order to best explain the present invention and its practical application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed. Many modifications and variations are possible in light of the above teaching without departing from the spirit and scope of the following claims.

What is claimed is:

1. An apparatus, said apparatus comprising:
a processor; and
memory, said memory being connected to said processor; and
a browser stored in said memory, said browser presenting a first window and a second window to a user, said first window being divided into a plurality of cells, each of said cells being associated with different segments of an image, said second window being used to display one of said different segments to said user.

2. The apparatus of claim 1 wherein said image is an original image.

3. The apparatus of claim 2 wherein said image is a desired image of a user-specified size.

4. The apparatus of claim 3 wherein said desired image is larger than said original image.

5. The apparatus of claim 3 wherein said desired image is smaller than said original image.

6. The apparatus of claim 1 wherein said first window is a thumbnail window.

7. The apparatus of claim 1 wherein said second window is a display screen.

8. The apparatus of claim 1 wherein a scaled down version of said image is presented in said first window.

9. A handheld device, said handheld device comprising:
a processor;
memory, said memory being connected to said processor; and
a browser stored in said memory, said browser presenting a thumbnail window and a first image segment of an image to a user, said thumbnail window being divided into a plurality of cells, a first one of said cells being associated with said first image segment, a second one of said plurality of cells being associated with a second image segment of said image, said second image segment not being presented to said user by said browser.

10. The handheld device of claim 9 wherein said image is an original image.

11. The handheld device of claim 10 wherein said image is a desired image of a user-specified size.

12. The handheld device of claim 11 wherein said desired image is larger than said original image.

13. The handheld device of claim 11 wherein said desired image is smaller than said original image.

14. The handheld device of claim 9 wherein a scaled down version of said image is presented in said thumbnail window.

15. A method, said method comprising the steps of:
retrieving a page for display using a browser;
producing an image from said page;
scaling said image to fit a display window; and
presenting said image in scaled form to a user using said browser.

16. The method of claim 15 wherein said display window is a screen of a handheld device.

17. A program product, said program product comprising:
signal bearing media; and
a program stored on said signal bearing media, said program presenting a first window and a second window to a user, said first window being divided into a plurality of cells, each of said cells being associated with different segments of an image, said second window being used to display one of said different segments to said user.

18. The program product of claim 17 wherein said image is an original image.

19. The program product of claim 18 wherein said image is a desired image of a user-specified size.

20. The program product of claim 19 wherein said desired image is larger than said original image.

21. The program product of claim 19 wherein said desired image is smaller than said original image.

22. The program product of claim 17 wherein said first window is a thumbnail window.

23. The program product of claim 17 wherein said second window is a display screen.

24. The program product of claim 17 wherein a scaled down version of said image is presented in said first window.

25. A program product, said program product comprising:
signal bearing media; and
a browser stored on said signal bearing media, said browser presenting a thumbnail window and a first image segment of an image to a user, said thumbnail window being divided into a plurality of cells, a first one of said cells being associated with said first image segment, a second one of said plurality of cells being associated with a second image segment of said image, said second image segment not being presented to said user by said browser.

26. The program product of claim 25 wherein said image is an original image.

27. The program product of claim 26 wherein said image is a desired image of a user-specified size.

28. The program product of claim 27 wherein said desired image is larger than said original image.

29. The program product of claim 28 wherein said desired image is smaller than said original image.

30. The program product of claim 25 wherein a scaled down version of said image is presented in said thumbnail window.

31. A method comprising the steps of:
retrieving a page for presentation to a user by a browser;
producing an image from said page;
presenting a first window and a second window to said user, said first window being divided into a plurality of cells, each of said cells being associated with different segments of said image, said second window being used to display one of said different segments to said user.

32. The method of claim 31 wherein said image is an original image.

33. The method of claim 32 wherein said image is a desired image of a user-specified size.

34. The method of claim 33 wherein said desired image is larger than said original image.

35. The method of claim 33 wherein said desired image is smaller than said original image.

36. The method of claim 31 wherein said first window is a thumbnail window.

37. The method of claim 31 wherein said second window is a display screen.

38. The method of claim 31 wherein a scaled down version of said image is presented in said first window.

39. A method, said method comprising the steps of:
retrieving a page for presentation to a user by a browser;
producing an image from said page;
presenting a thumbnail window and a first image segment of an image to a user, said thumbnail window being divided into a plurality of cells, a first one of said cells being associated with said first image segment, a second one of said plurality of cells being associated with a second image segment of said image, said second image segment not being presented to said user by said browser.

40. The method of claim 39 wherein said image is an original image.

41. The method of claim 40 wherein said image is a desired image of a user-specified size.

42. The method of claim 41 wherein said desired image is larger than said original image.

43. The method of claim 41 wherein said desired image is smaller than said original image.

44. The method of claim 39 wherein a scaled down version of said image is presented in said thumbnail window.
